(19) United States
(12) Patent Application Publication
(10) Pub. No.: US 2015/0122765 A1
(43) Pub. Date: May 7, 2015

(54) Insulated Baby Bottle

(71) Applicants: Mesha Cannon, Cincinnati, OH (US); Cheron Reid, Fairfield, OH (US)

(72) Inventors: Mesha Cannon, Cincinnati, OH (US); Cheron Reid, Fairfield, OH (US)

(21) Appl. No.: 14/534,280

(22) Filed: Nov. 6, 2014

Related U.S. Application Data
(60) Provisional application No. 61/901,395, filed on Nov. 7, 2013.

(51) Int. Cl. A61J 9/02; A61J 9/08

(52) U.S. Cl. CPC A61J 9/02; A61J 9/08
USPC 215/11.2; 215/11.6

(57) ABSTRACT

An insulated baby bottle having a temperature indicator thereon. The baby bottle has a cylindrical construction with an open lower end and an open upper end. The upper end of the baby bottle is preferably angled. A cap having a nipple thereon can be removably secured to the upper end of the baby bottle to allow a baby to feed therefrom. The lower end includes a removable base thereon so that the baby bottle can be easily cleaned. The base includes a window on the lower surface thereof through which any of various indicia can be displayed. The indicia are positioned on a wheel that is rotatable by a user so that the window can display a desired indicia, such as the word “hot” or “cold” among others. Further, the lower end of the baby bottle may include a temperature display for measuring and displaying the temperature of bottle's contents.

### CROSS REFERENCE TO RELATED APPLICATION

This application claims the benefit of U.S. Provisional Application No. 61/901,395 filed on Nov. 7, 2013. The above identified patent application is herein incorporated by reference in its entirety to provide continuity of disclosure.

### BACKGROUND OF THE INVENTION

1. Field of the Invention

The present invention relates to a baby bottle. More specifically, the present invention provides an insulated baby bottle having a removable cap and base, and further having a temperature indicator thereon. The removable base allows the container to be easily cleaned, and the base may include indicia thereon for identifying the contents of the baby bottle or for indicating the temperature thereof.

Babies need to be fed throughout the day, and parents or guardians must have a bottle readily available at all times. However, the contents of the bottle, such as formula, may need to be maintained at a particular temperature. If the formula or other substance is not maintained at a proper temperature, the formula may spoil or the baby may refuse the bottle if the contents become too hot or cold. Thus, it is important for the contents of the bottle to be maintained at a proper temperature.

Accordingly, many parents travel with ice packs and bottle warmers in order to maintain or adjust the temperature of a bottle of formula or other substance. However, carrying these additional items can be cumbersome and inconvenient for the parent. Further, the ice packs and bottle warmers may not be suitable for use over an extended period of time, as the ice packs will warm throughout the day. Thus, a device that allows users to maintain a baby bottle at a desired temperature for an extended period of time is desired.

2. Description of the Prior Art

Devices have been disclosed in the prior art that relate to baby bottles. These include devices that have been patented and published in patent application publications. These devices generally relate to insulated baby bottles having a multi-wall construction. The following is a list of devices deemed most relevant to the present disclosure, which are herein described for the purposes of highlighting and differentiating the unique aspects of the present invention, and further highlighting the drawbacks existing in the prior art.

One such device, U.S. Published Patent Application Number 2008/0093370 to Darsey discloses an insulated beverage container housing. The container housing includes a wall defining a body portion, wherein the wall has a cavity. The body portion further includes a slot in the wall. The slot accommodates a handle that extends radially from the container. Thus, Darsey discloses an insulated beverage container, but does not disclose a baby bottle having a removable lid and base, and does not include a temperature display or similar device.

U.S. Pat. No. 6,164,469 to Sartore discloses a thermal insulated bottle. The bottle includes an inner container adapted to receive a liquid therein, enclosed within an outer housing. The inner container and outer housing are coupled by sealing connection elements to define an airtight space therebetween. The hollow space may include ornamental or indicating elements. Thus, while Sartore discloses a baby bottle having insulation, the device does not include a removable base and lid.

U.S. Pat. No. 3,661,288 to Noll discloses an insulated nursing bottle. The walls of the nursing bottle include spaced elements that may be packed with an insulating filling, such as Styrofoam. The device further includes a nipple-cap having a nipple portion. The device includes a straw having an end inside of the bottle that is turned upon itself so that intake and exhaust ends face the upper portion of the cap. Thus, Noll discloses a baby bottle, but fails to disclose a baby bottle having a removable base, and having temperature indicating means.

U.S. Pat. No. 3,096,897 to Hansen discloses an insulated container. The container includes an inner container and an outer casing, each having a neck portion. The neck portions are nested so that the inner container and outer casing are locked together. The space between the inner container and outer casing provides insulation. Thus, while Hansen discloses the construction of an insulated container, Hansen does not disclose a baby bottle having a removable lid and base, nor does Hansen disclose means for indicating the temperature of the container.

Finally, U.S. Pat. No. 5,156,284 to del Pilar Pla Rodriguez et al. discloses a thermally insulated baby bottle. The device includes a multi-wall container having an axially disposed window that allows a user to see the interior of the container. The device further includes a spill-proof plug and an attachable nipple. Thus, the device does not include a removable base or a temperature indicating device.

These prior art devices have several known drawbacks. The devices in the prior art relate to insulated baby bottles of various construction. These devices, however, do not provide a baby bottle having a removable lid and base. Such bottles may be more difficult to clean and are of more complex construction. Further, many devices lack means for indicating the temperature of the contents of the baby bottle, preventing the caregiver from knowing whether the contents of the bottle are at a proper temperature for a baby to consume.

In light of the devices disclosed in the prior art, it is submitted that the present invention substantially diverges in design elements from the prior art and consequently it is clear that there is a need in the art for an improvement to existing insulated baby bottle devices. In this regard the instant invention substantially fulfills these needs.

### SUMMARY OF THE INVENTION

In view of the foregoing disadvantages inherent in the known types of insulated baby bottles now present in the prior art, the present invention provides a new insulated baby bottle wherein the same can be utilized for providing convenience for the user when maintaining the contents of a baby bottle at a desired temperature for an extended period of time.

It is therefore an object of the present invention to provide a new and improved insulated baby bottle device that has all of the advantages of the prior art and none of the disadvantages.

It is another object of the present invention to provide an insulated baby bottle having a double-wall construction so as to help maintain the contents of the baby bottle at the desired temperature.

Another object of the present invention is to provide an insulated baby bottle having a removable base and lid so that the bottle and components are easily cleaned.

Yet another object of the present invention is to provide an insulated baby bottle having a thermometer or similar temperature indicating means thereon.

Another object of the present invention is to provide an insulated baby bottle having a base adapted to display various indicia thereon regarding the temperature or contents of the baby bottle.

A further object of the present invention is to provide an insulated baby bottle that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the insulated baby bottle of the present invention.

FIG. 2 shows a disassembled view of the insulated baby bottle of the present invention.

FIG. 3 shows a bottom view of the insulated baby bottle of the present invention.

FIG. 4 shows a view of an embodiment of the baby bottle of the present invention having a temperature display thereon.

### DETAILED DESCRIPTION OF THE INVENTION

Reference is made herein to the attached drawings. Like reference numerals are used throughout the drawings to depict like or similar elements of the insulated baby bottle. For the purposes of presenting a brief and clear description of the present invention, the preferred embodiment will be discussed as used for maintaining the contents of a bottle at a desired temperature for an extended period of time. The figures are intended for representative purposes only and should not be considered to be limiting in any respect.

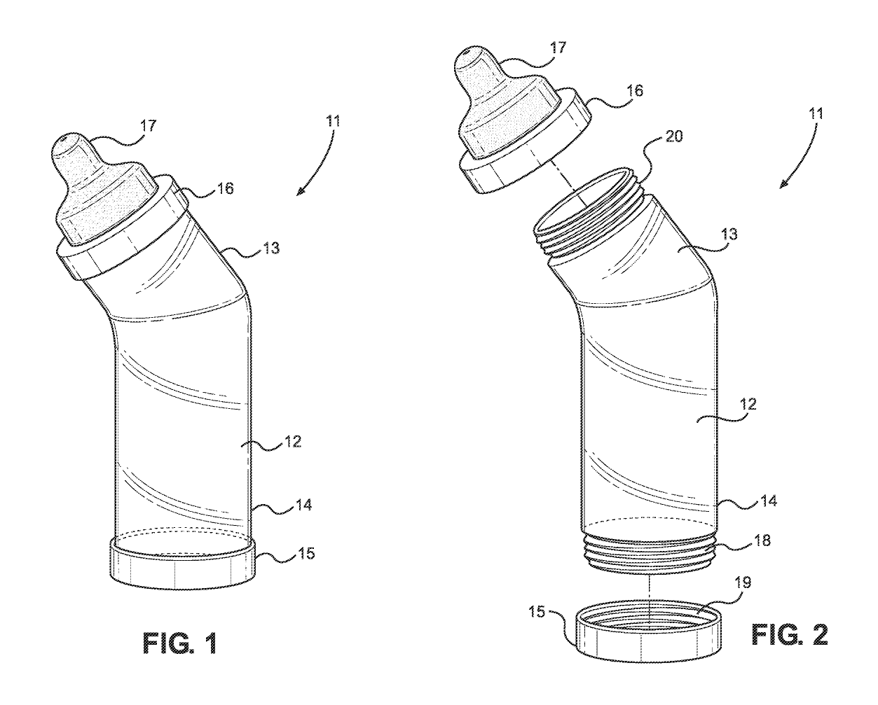

Referring now to FIGS. 1 and 2, there is shown a perspective view of the insulated baby bottle of the present invention and a disassembled view of the baby bottle of the present invention. The baby bottle 11 of the present invention comprises a cylindrical container 12 having an open upper end 13 and an open lower end 14. The container 12 preferably includes a bent or angled upper end 13. In this way, the baby bottle 11 can be more easily used to feed a baby in that the bottle 11 does not need to be fully inverted for feeding. The container 12 is preferably composed of a hard, durable plastic, and may be transparent.

The container 12 comprises an insulated construction so as to minimize heat transfer into or out of the container 12. In some embodiments, the container 12 includes a double-walled construction such that there is an outer wall separated from an inner wall by a hollow space. In other embodiments, the container 12 includes an inner wall having an insulating material disposed thereon. In this way, the contents of the container 12 can remain at a desired temperature for an extended period of time, as the insulation minimizes heat transfer into or out of the container. Thus, the outer wall of the container 12 will remain cool to the touch, so that the warmth of the contents of the container is not felt through the wall thereof.

The upper end 13 of the container 12 is adapted to removably receive a lid 16 having a nipple 17 thereon. The nipple 17 is porous and allows liquid to pass therethrough so that a baby may feed from the nipple 17. Preferably, the exterior of the upper end 13 is threaded 20 so as to engage a lid 16 having a threaded interior. This allows the lid 16 to be easily secured to and removed from the container 12. Thus, when the lid 16 is removably secured to the upper end 13 of the container 12, the nipple 17 thereon is in fluid communication with the liquid held within the container 12.

Further, the baby bottle 11 includes a base 15 that is removably secured to the lower end 14 of the container 12. The base 15 is adapted to enclose the lower end 14 of the container 12 so that liquid or another substance can be stored within the container 12 without leaking or otherwise escaping therefrom. Preferably, the lower end 14 of the container 12 includes threading 18 thereon so as to receive the threaded interior 19 of the base 15. The base 15 can be secured so as to produce a water-tight seal so that the container 12 will not leak. Thus, the base 15 and the lid 16 can be easily removed from the container 12 so that the container 12 can be cleaned separately from the base 15 and the lid 16.

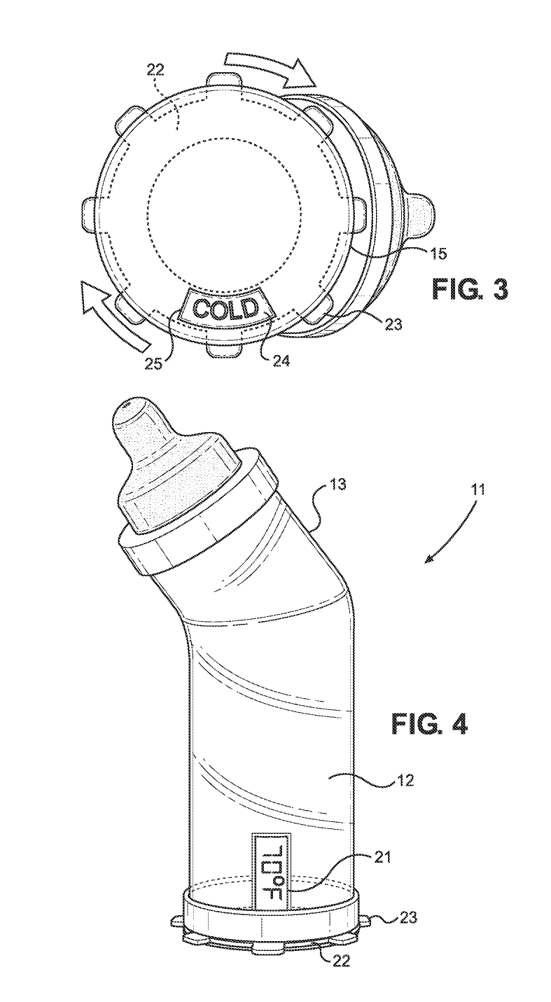

Referring now to FIG. 3, there is shown a bottom view of the insulated baby bottle of the present invention. In the illustrated embodiment, the base 15 includes a planar bottom surface having a window 25 thereon. A wheel 22 having indicia 24 thereon is positioned inside of the base 15 adjacent to the bottom surface thereof. The wheel 22 can be rotated by a user so that different indicia 24 are displayed through the window 25. The wheel includes a plurality of knobs 23 on the periphery thereof that a user can engage with his or her fingers in order to turn the wheel so that different indicia 24 show through the window 25. The knobs 23 extend outward from the base 15 through a slot that extends around the circumference of the base 15. The indicia 24 may describe the temperature of the container, or may describe the contents of the container. For example, the indicia may read “HOT” or “COLD,” or may say “WATER,” “JUICE,” or “FORMULA.” The indicia 24 are arranged in a ring shape around the periphery of the wheel 22. Accordingly, the wheel 22 may be circular or annular in shape.

Referring now to FIG. 4, there is shown an embodiment of the baby bottle of the present invention having a temperature display thereon. The illustrated embodiment includes a temperature display 21 that indicates the temperature of the contents of the container 12. The temperature display 21 includes a temperature sensor or thermometer that can determine the temperature of the contents of the container. Preferably, the temperature display 21 is digital and includes a power source, such as one or more batteries stored therein. The temperature display 21 can be integrated into the base 15 or may be disposed on the lower end 14 of the container 12 as shown in FIG. 4. The temperature display 21 is located on the base 15 or lower end 14 of the container 12 so that it is in contact with the portion of the container 12 having liquid therein. The temperature display 21 helps the user to determine the temperature of the contents of the container, as the insulation eliminates the user's ability to touch the container 12 to determine if the container's contents are hot or cold. Thus, the temperature display 21 allows a user to more precisely determine the temperature of the contents of the bottle in order to determine if the contents are at a proper temperature for feeding a baby.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An insulated baby bottle, comprising:
a container having an open upper end and an open lower end;
a lid having a nipple thereon, wherein said lid is removably securable to said open upper end of said bottle;
a base removably securable to said open lower end of said bottle so as to enclose said lower end of said bottle;
a temperature indicator disposed on said container.

2. The insulated baby bottle of claim 1, wherein said open upper end comprises threading on an exterior thereof adapted to engage with threading on the interior of said lid.

3. The insulated baby bottle of claim 1, wherein said open lower end comprises threading on an exterior thereof adapted to engage with threading on an interior of said base.

4. The insulated baby bottle of claim 1, wherein said container is substantially cylindrical and includes an angled upper end.

5. The insulated baby bottle of claim 1, wherein
said base includes a planar bottom surface having a window thereon;
wherein said temperature indicator comprises a wheel having indicia thereon, wherein said wheel is rotatably positioned within said base such that said indicia can be displayed through said window;
wherein said indicia indicate the temperature of a substance within said container.

6. The insulated baby bottle of claim 5, wherein said wheel includes a plurality of knobs thereon that can be engaged by a user in order to rotate said wheel within said base.

7. The insulated baby bottle of claim 1, wherein said temperature indicator includes a digital temperature display.

8. The insulated baby bottle of claim 1, wherein said container comprises a double-walled construction.

9. The insulated baby bottle of claim 1, wherein said container includes a layer of insulating material thereon.
